(19) United States
(12) Patent Application Publication
(10) Pub. No.: US 2007/0232707 A1
(43) Pub. Date: Oct. 4, 2007

(54) Method of increasing the cell volume of PUR foams

(75) Inventors: Bodo Benitsch, Buttenwiesen (DE); Torsten Matheke, Wertingen (DE); Alfred Chodura, Augsburg (DE); Karin Rossberg, Augsburg (DE)

Correspondence Address: LERNER GREENBERG STEMER LLP, P O BOX 2480, HOLLYWOOD, FL, 33022-2480, US

(73) Assignee: SGL Carbon AG

(21) Appl. No.: 11/238,479

(22) Filed: Sep. 29, 2005

(30) Foreign Application Priority Data
Sep. 29, 2004 (EP) 04023181.3

(51) Int. Cl. C08J 9/00

(52) U.S. Cl. 521/50

(57) ABSTRACT

The mean pore number of conventional open-celled PUR foams having at least 8 ppi can be significantly reduced if the foam is stored in a liquid compound having an aromatic skeleton and at least one hydroxy group or in another compound dissolved in a solvent. During the treatment, the foam experiences an increase in volume of at least 10% without the pores collapsing. Ceramic foams produced from open-celled PUR foam having a mean pore count of less than 8 ppi are particularly suitable as flame zone structure for pore burners.

### BACKGROUND OF THE INVENTION

1. Field of the Invention

The present invention relates to a method of increasing the cell volume of open-celled polyurethane foams and the application of the foams produced in this way.

Polyurethanes (frequently abbreviated as PU or PUR; the abbreviation PUR will be used in the following) are obtainable by polyaddition of divalent or higher-valent alcohols (e.g. polyester diols or/and polyether diols) and isocyanates. Depending on the choice and stoichiometric ratio of the starting materials, it is possible to produce polyadducts having different property profiles, e.g. in respect of density and hardness. Bifunctional alcohols and isocyanates give linear, thermoplastic products, while polyfunctional starting materials (e.g. trihydric alcohols) react to form branched or cross-linked polyadducts. Polyurethanes having polyesters or polyether diols as diol components are frequently referred to as polyester polyurethane or polyether polyurethane, respectively.

To produce polyurethane foams, the polyaddition is carried out in the presence of water or carboxylic acids since these react with the isocyanates to eliminate CO₂ that has a blowing action. To optimize the foam structure, volatile substances, e.g. chlorofluorocarbons (CFCs) or methylene chloride, may be used as blowing agents. However, the use of CFCs as blowing agents is no longer permissible in Germany in order to protect the environment and health.

One further development in foam technology that overcomes this problem is the use of liquid carbon dioxide as an alternative blowing agent. A second alternative that is very complicated in terms of plant engineering is foaming under constant atmospheric conditions in a closed system. At subatmospheric pressure, it is possible to produce, in particular, foams having a low density without the addition of a blowing agent.

The particular advantage of PUR foams as materials is that the cell structure ensures flexibility, elasticity and shape stability combined with a low weight. Owing to the wide range of product properties displayed by them, polyurethane foams are employed in many fields. Main fields of use are upholstered furniture, cushions, mattresses, vehicle seats, automobile body parts, housings and packaging, insulation and sound insulation and also filters. Typical properties of PUR foams based on polyethers or polyesters are shown in the following table.

| | Polyether | Polyester |
|---|---|---|
| Foam density [kg/m³] | 20-110 | 20-60 |
| Compressive strength [kPa] | 1.5-20 | 2-7 (50) |
| Tensile strength [kPa] | 90-400 | 100-560 |
| Elongation at break [%] | 90-300 | 40-500 |
| Air permeability [l/(m² * s)] | 1100-4500 | 750-8000 |
| Pores per inch [ppi] | 10-60 | 8-90 |

An important parameter for characterizing the pore structure of the foams is the number of pores per unit length. This is usually reported as pores per inch (ppi for short). The range of variation of commercially available PUR foams extends from fine-pored foams having more than 100 ppi to relatively coarse-pored foams having about 8 to 10 ppi.

The above-described procedure gives foam structures having closed pores. Open-celled foam structures can be obtained by subsequent destruction of the cell walls (known as reticulation). Here, the cell walls are ripped open by action of a shock wave of an explosion, for example a hydrogen/oxygen gas explosion, and a characteristic framework made up of struts having a usually triangular strut cross section remains.

Open-celled polyurethane foam can be used as a starting material for the production of open-celled metal or ceramic foams. The production of foam ceramics contains, in a known manner, the basic steps of the provision of a prestructure, e.g. in the geometry of a future component, composed of an open-celled polymer foam, coating of the cell struts of the prestructure with a suspension (slurry) of ceramic particles or/and particles which form ceramic on high-temperature treatment, if appropriate with the addition of auxiliaries such as sintering aids, thickeners and/or fluidizers in water or another solvent, squeezing-out and drying of the coated polymer foam, curing of the coating, burn-out or pyrolysis of the polymer material and sintering of the remaining ceramic coating. An industrially utilized process of this type is known from U.S. Pat. No. 3,090,094.

The burn-out of the polymer material inevitably leads to voids remaining in place of the struts in the polymer foam used as the starting material. As a result, the strength of the ceramic foams obtained in this way is relatively low. According to European patent EP 0 907 621 (corresponding to U.S. Pat. No. 6,635,339), a solution to this problem contains impregnating the foam ceramic with a melt or suspension during or after sintering and subsequently heating the materials present in the suspension or their reaction products to a temperature above the melting point. As a result, the voids in the ceramic struts are filled and any cracks and pores formed are closed. The melts or the solids of the suspension contain materials which melt below the melting point of the foam ceramic, have a similar coefficient of expansion as the foam ceramic, wet this very well and do not react with constituents of the foam ceramic.

Alternatively, the voids can be filled and cracks closed by a gas-phase infiltration process of suitable materials. Open-celled foam ceramic, especially foam ceramic based on silicon carbide, is suitable, inter alia, for the production of burn elements in area radiation burners, volume burners and pore burners because of its permeability and high-temperature resistance.

PUR foams having an approximately homogeneous pore distribution can be produced industrially only up to a pore size of from about 8 to 10 ppi. When the pore volume is increased further, the structures collapse under their own weight. However, a structure having larger pores would be advantageous for particular applications. Thus, for example, filters could have a more open structure and the throughput could be increased thereby.

In pore burners having ceramic foam in the flame zone, enlargement of the pores within particular limits produces a lowering of the temperature of the ceramic foam and more rapid homogenization of the temperature distribution in non-steady-state processes such as start-up operation or load changes. This lowering of the thermal load increases the life of the foam structure at the same power, or a higher power density compared to conventional ceramic foams can be achieved at the same life. The decisive criterion for flame formation is that the Peclet number exceeds a critical value of 65. The Peclet number is in turn directly proportional to the pore diameter, as can be seen from the following definition:
Pe=(S_{L}*dₘ*c_{P}*ρ_{f})/λ_{f} (1)
where S_{L} [m/s] is the laminar combustion velocity, dₘ [m] is the equivalent pore diameter, c_{P} [J/kg*K] is the specific heat capacity of the gas mixture, ρ_{f} [kg/m³] is the density of the gas mixture and λ_{f} [W/m*K] is the thermal conductivity of the gas mixture.

It is thus desirable to make available both PUR foams having a smaller PPI number and corresponding ceramic foams.

### SUMMARY OF THE INVENTION

It is accordingly an object of the invention to provide a method of increasing the cell volume of PUR foams, which overcomes the above-mentioned disadvantages of the prior art methods of this general type, which allows the pore volume of each individual pore and thus of the total structure to be increased without the stability of the foam structure being reduced to such an extent that it collapses and falls into itself.

With the foregoing and other objects in view there is provided, in accordance with the invention, a process for producing an final open-celled polyurethane foam having a mean pore count of less than 8 pores per inch (ppi). The process includes storing an open-celled polyurethane foam having a mean pore count of greater than or equal to 8 ppi in a substance having an aromatic skeleton and at least one hydroxyl group. The substance is either a first substance being liquid or a second substance being dissolved in a solvent. This results in the open-celled polyurethane foam experiencing an increase in volume of at least 10%.

It is known that PUR displays swelling phenomena when acted on by particular organic compounds such as acetone or ethyl acetate. However, the substances do not produce any widening of the pore structure of PUR foams. It was therefore an object of the invention to find more effective substances that bring about a widening of the pore structure of the PUR foams.

It has surprisingly been found that an increase in the volume with a parallel reduction in the number of pores per unit length by up to one third can be achieved in PUR foams on contact with particular chemicals that had previously not been known to have a swelling effect on PUR. The mechanical stability of the foam structure is not appreciably decreased by this. The effect can be reinforced by thermal treatment, i.e. heating, and mechanical action, e.g. clamping of the foam structure.

Compounds which have an aromatic skeleton, e.g. a phenyl ring (benzene ring) and at least one hydroxy group, in particular hydroxy groups capable of dissociation, and are liquid or readily soluble in customary solvents, preferably water, have been found to be particularly effective for widening the foam structure, i.e. enlarging the pores.

The simplest representative of this group of compounds is phenol (hydroxybenzene). Although its use in the process of the invention is in principle possible, it is undesirable because of the toxicity of this substance. According to the invention, preference is therefore given to using less volatile and less harmful substances that have the abovementioned structural feature.

These requirements are met, for example, by compounds from the group of phenolic resins. Phenolic resins are formed by condensation of phenols and aldehydes. As aldehyde component, use is made virtually exclusively of formaldehyde, while phenol components used are not only phenol itself but also aryl- or alkyl-substituted phenols (e.g. xylenols, cresols) or polyhydric phenols (e.g. resorcinol, bisphenol A).

The structure of the condensation products is dependent on the molar ratio of the starting materials and the catalysts used. An excess of phenol and acid catalysis leads to the formation of compounds in which phenyl rings bearing hydroxy groups are joined to one another via methylene groups. These compounds, known as novolaks, are soluble, fusible and not self-curing, but can be cured by addition of a further formaldehyde-releasing hardener, e.g. hexamethylenetetramine.

In the case of an excess of formaldehyde and basic catalysis, products in which phenyl rings bearing hydroxy groups are at least partly joined to one another via methyl ether bridges instead of methyl groups and the phenyl rings are, in addition, partly substituted by hydroxymethyl groups are obtained. Owing to the reactivity of the methyl ether groups and the hydroxymethyl groups, these compounds are, in contrast to novolaks, self-curing and therefore have limited stability in the liquid or dissolved state.

It is known that not only the methylene bridges but also the phenolic hydroxy groups are involved in the formation of the structure of the fully cured phenolic resins as a result of formation of hydrogen bonds. Since polyurethanes also contain building blocks that, due to their polarity, are suitable partners for the formation of hydrogen bonds, it is assumed that interactions via hydrogen bonds between the phenolic hydroxy groups and the functional groups of the polyurethanes play a role in the process of the invention, too. However, the invention is not tied to this explanation.

Furthermore, it is assumed that the space requirement of the phenyl rings or/and their spatial configuration plays a role in the widening of the foam structure.

A further substance that is suitable for the process of the invention is benzyl alcohol (phenylmethanol). Benzyl alcohol is, in contrast to phenol, classified as having a low toxicity. Since benzyl alcohol is in the liquid state at room temperature, it can be employed directly in undiluted form.

In the process of the invention, the substances which effect pore widening can be employed either undiluted in liquid form or, for example, as aqueous or alcoholic solutions or solutions in mixtures of water and an alcoholic solvent. The use of water as solvent is preferred for reasons of cost and disposal. The PUR foam bodies that have been produced and converted in open-celled foams in a known manner are stored in the treatment solution for a period of from some minutes to a number of hours.

As a result of this treatment, which can be aided by elevated temperature, application of reduced pressure or application of a tensile stress to the foam structure, the dimensions (length, width and height) of the foam bodies increase by from 10 to 50% in each spatial direction as a function of the treatment time and the concentration of the solution used. The lower the concentration of the solution, the greater the influence of the treatment time, while at relatively high concentrations prolonging of the treatment time above a particular minimum no longer effects any significant pore widening. A saturation phenomenon is obviously present here.

The pores remain open as a result of the treatment according to the invention; collapse of the pores or of the entire structure was not observed. The number of pores in the treated foam body remains constant. Since, however, the length of the body increases, the same number of pores is now distributed over a greater length, as a consequence of which the number of pores per inch as length unit (ppi) is smaller than in the original state. In terms of the overall geometry, this results in an increase in the volume at a constant number of pores.

If foams having a mean pore count of, for example, 10 ppi are used as starting material, foams having a mean pore count of about 6.5 ppi can be produced therefrom by the process of the invention. When foam structures having a mean pore count of 8 ppi (upper limit according to the present-day state of the art) are used as starting material, pore counts of from 5.5 to 5 ppi, which have hitherto not been commercially available, can be produced by the process of the invention.

If the widening of the pores is to be aided by application of a tensile stress, this can be achieved by clamping the foam structure into a frame whose dimensions correspond to the dimensions of the foam structure to be expected as a result of the treatment, which have been determined by preliminary tests.

An important field of application of the PUR foams produced by the process of the invention is the production of metal and ceramic foams. In this context, it is particularly advantageous if the processes of widening the pores and of coating the foam structure with the ceramic or ceramic-forming particles are coupled. For this purpose, the particles with which the foam structure is to be coated are dispersed in the liquid pore-widening substance or the solution of the pore-widening substance. The further process steps follow the processes known from the prior art, for example U.S. Pat. No. 3,090,094 or European patent EP 0 907 621 (corresponding to U.S. 6,635,339), and comprise essentially the basic steps of squeezing-out and drying of the coated polymer foam, curing of the coating and burn-out or pyrolysis of the polymer material and sintering and, if appropriate, gas- or liquid-phase infiltration of the ceramic coating which remains.

PUR foams having a mean pore count of less than 8 ppi produced by the process of the invention and ceramic or metal foams having a mean pore count of less than 8 ppi produced therefrom can, for example, be used as filters.

Ceramic foam structures having less than 8 ppi which have been produced from the PUR foams treated by the process of the invention are particularly suitable as flame zone structures for the combustion chambers of pore burners. Such burners are known, for example, from the patent specifications European patents EP 0 657 011 (corresponding to U.S. Pat. No. 5,522,723) and EP 1 212 258. In the combustion chamber there is a porous material which has contiguous voids and whose pore size increases in the flow direction of the gas/air mixture from the inlet to the outlet either continuously, within a transition zone, or discontinuously, i.e. at an interface, so that the critical Peclet number for flame formation is exceeded in the transition zone or at the interface. While flame formation is suppressed upstream of the interface or into the transition zone, a flame can form downstream of the interface or transition zone.

If the ceramic foam having the pores that have been enlarged according to the invention is used for the region above the critical Peclet number, i.e. in the actual combustion zone, the fuel gases flow more readily through this region and the heat produced during combustion is removed more readily. The foam remains cooler at the same combustion power, as a result of which its life is increased.

In addition, upon start-up of the burner, the time to formation of a uniformly distributed flame, which in the case of pore burners typically draws back into the foam structure on reaching steady-state combustion, is shortened.

A Peclet number of more than 65 is critical for flame formation. Owing to the direct dependence of the Peclet number on the pore size (equation (1)), the pore size therefore also has to exceed a critical minimum value if flame formation is to occur. The fewer the pores that exceed this limit, the fewer potential regions (pores) at which initial flame formation can take place are there in the foam. The further flames typically go out from these “nucleation zones” and extend over the entire foam. As the number of pores above the critical limit increases, there are accordingly more nucleation zones for flame formation. The foam heats up more uniformly, more homogeneously and therefore more quickly. A similar situation applies to load changes in which the power of the burner is increased or reduced.

The process of the invention thus makes it possible to equip pore burners with ceramic foams which, thanks to their mean pore count of less than 8 ppi, meet these pore structure requirements.

Other features which are considered as characteristic for the invention are set forth in the appended claims.

Although the invention is described herein as embodied in a method of increasing the cell volume of PUR foams, it is nevertheless not intended to be limited to the details described, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments.

### DESCRIPTION OF THE PREFERRED EMBODIMENTS

### EXAMPLE 1

Test specimens of PUR foam having a mean pore count of 10 ppi were stored in aqueous solutions of phenol at room temperature. The dimensions of the specimens (length×width) were 20 mm×20 mm. Three parallel specimens were stored in a solution having a phenol content of 0.5% by mass and three further specimens were stored in a solution having a phenol content of 5% by mass. The specimens were completely immersed in the respective solutions.

After a storage time of 2 and 24 hours, the length and width and the pore count of the specimens were determined in each case. The results are shown in Table 1. The percentage changes in length are all based on the length in the initial state, i.e. before storage.

TABLE 1
Results of the storage tests in aqueous solutions of phenol

| | Phenol content of the solution in | | | | | | | | | | | | | | | | | |
|---|---|---|---|---|---|---|---|---|---|---|---|---|---|---|---|---|---|---|
| | percent by mass | | | | | | | | | | | | | | | | | |
| | 0.5% | | | | | | | | | 5% | | | | | | | | |
| | Duration of test/hours | | | | | | | | | | | | | | | | | |
| | 0 | | | 2 | | | 24 | | | 0 | | | 2 | | | 24 | | |
| | Specimen No. | | | | | | | | | | | | | | | | | |
| | 1 | 2 | 3 | 1 | 2 | 3 | 1 | 2 | 3 | 1 | 2 | 3 | 1 | 2 | 3 | 1 | 2 | 3 |
| Length/mm | 20 | 20 | 20 | 23 | 23 | 22 | 23 | 24 | 24 | 20 | 20 | 20 | 33 | 32 | 33 | 31 | 29 | 29 |
| Length change/% | — | — | — | 15 | 15 | 10 | 15 | 20 | 20 | — | — | — | 65 | 60 | 65 | 55 | 45 | 45 |
| Pore count/PPI | 10 | 10 | 10 | 9 | 9 | 9 | 9 | 8 | 8 | 10 | 10 | 10 | 6 | 6 | 6 | 6 | 7 | 7 |

While the majority of the specimens stored in the less concentrated phenol solution displayed a further increase in length when the duration of the test was extended from 2 to 24 hours, the length growth in the more concentrated solution stagnates after 2 hours or even goes backward to a slight extent. On the other hand, it was observed that appreciable swelling of the specimen commenced after a storage time of only about 5 minutes in the more concentrated solution. In the case of preliminary tests using an aqueous solution having a phenol content of 9% by mass, too, a considerable widening of the foam structures was observed after only a few minutes after commencement of storage.

It can be concluded from these findings that swelling is increased and accelerated with increasing phenol concentration, although saturation also occurs more quickly, as a result of which the change in length and pore widening stagnates.

After the storage experiment, the specimens were kept at room temperature for a further 24 hours and the length and mean pore count were determined again. Here, a significant reversal of the length change was observed: the specimens now had a length that was only 5-35% greater than their original dimensions. Correspondingly, the ppi count has also gone back to closer to the initial value.

To be able to utilize the effect of pore widening in the best possible way, it would thus be necessary to process the foams further while still wet immediately after storage in the phenol solution, i.e. coat them immediately with the slurry for the ceramicization. However, it needs to be remembered that the use of phenol as pore widening agent should be avoided because of its toxicity.

### EXAMPLE 2

The swelling action of various substances was tested on further test specimens of PUR foam having a mean pore count of 10 ppi. The width and length of the specimens were determined in each case both before and after storage in the test medium.

Specimens which had been stored in ethyl acetate or acetone did not display any signs of pore widening after either 2 or 24 hours, although it is known from the technical plastics literature that these substances effect swelling of polyurethane. A further specimen having dimensions of 25 mm×24 mm (length×width) was treated in a 5% strength aqueous solution of resorcinol (a phenol having two hydroxy groups). After storage for 2 hours at room temperature, the specimen dimensions were 28 mm×28 mm, and after 24 hours they were 29 mm×29 mm, i.e. they had increased by about 20%. This corresponds to a reduction in the mean pore count to about 8 ppi.

A further specimen having the dimensions 21 mm×22 mm (length×width) was stored in undiluted benzyl alcohol. After 2 hours, the dimensions of the specimen had increased to 29 mm×30 mm and after 24 hours they had increased to 30 mm×31 mm, i.e. by about 30%. This corresponds to a reduction in the mean pore count to about 7.6.

### EXAMPLE 3

Test specimens of PUR foam having a mean pore count of 8 ppi were stored in solutions having various concentrations of a commercial phenolic resin of the resol type for 24 hours at room temperature and were subsequently dried at 40° C. for 2 hours in a drying oven. During storage in the solution, the specimens were completely covered by the solution. Before and after storage, after drying and after storage for a further two days at room temperature, specimen length and mean pore count were determined. The results are shown in Table 2. The percentage changes in length are all based on the length in the initial state, i.e. before storage in the solution. Tests were carried out using three different concentrations of the phenolic resin solution. A different foam specimen was utilized for each test. The solutions having a lower resin content were obtained by dilution of the 100% strength resin solution with ethanol.

TABLE 2
Results of the storage tests in solutions of phenolic resin

| | Phenolic resin content of the solution | | | | | | | | |
|---|---|---|---|---|---|---|---|---|---|
| | 100% | | | 50%/50% ethanol | | | 33.3%/66.7% ethanol | | |
| | Duration of the test/hours | | | | | | | | |
| | | | Drying | | | Drying | | | Drying |
| | | | for 2 h, | | | for 2 h, | | | for 2 h, |
| | 0 | 24 | 40° C. | 0 | 24 | 40° C. | 0 | 24 | 40° C. |
| Length/ | 65 | 80 | 80 | 75 | 90 | 90 | 70 | 85 | 85 |
| mm | | | | | | | | | |
| Change | — | 23 | 23 | — | 20 | 20 | — | 21 | 21 |
| in | | | | | | | | | |
| length/ | | | | | | | | | |
| % | | | | | | | | | |
| Pore | 8 | 6.5 | 6.5 | 8 | 6.7 | 6.7 | 8 | 6.6 | 6.6 |
| count/ | | | | | | | | | |
| PPI | | | | | | | | | |

A change in length of from 20 to 23% was observed as a result of storage in phenolic resin at all concentrations used. The change in length obviously does not depend significantly on the resin concentration. The concentration of the functional groups producing the effect were probably above a critical value above which a further increase in the concentration no longer produces an increase in the effect for all solutions used. It is assumed that this observation reflects the saturation phenomenon mentioned above.

Drying resulted in no measurable reversal of the pore widening which was retained even after the specimen had been kept at room temperature for two days. It is therefore not absolutely necessary for the specimens to be processed further while still moist.

The stability of the pore widening as a result of the treatment with solutions of phenolic resin instead of phenol is presumably attributable to the incipient curing of the resin during drying or to the solidification of the resin which precedes curing. The curing of the resin deposited on the foam structure results in the widened structure of the foam being, so to speak, frozen.

The residual resin remaining on the foam structure does not interfere in the further processing to produce metallized or ceramicized foams, since the polymer framework is in any case removed by pyrolysis. It was in fact found that the wetting properties of the PUR foam coated with phenolic resin could be influenced positively, so that the slurry of ceramic-forming or/and ceramic particles applied in the following step could be applied in a larger amount (mass of particles applied per surface area of foam).

Silicon carbide foams which are suitable, inter alia, for use in pore burners could be obtained from the foam structures widened by storage in phenolic resin solution in a known manner by coating of the struts with a slurry containing silicon carbide, drying, thermal after-treatment and after-densification by liquid-phase infiltration.

### EXAMPLE 4

To rationalize the process for producing ceramic foams, it is attractive to combine the processes of pore widening and of coating the struts with the ceramic or ceramic-forming particles. For this purpose, silicon carbide powder was added to the ethanolic solutions of phenolic resin described in Example 3 to give a slurry. PUR foam structures having a pore count of on average 8 or 10 ppi were stored in this slurry.

A critical factor in this variant for achieving a good quality coating is that the storage time has to be low enough for the pore widening to be fully concluded after storage. If the coated foam structures are taken from the slurry too soon, the pore widening process continues and cracks are formed in the coating as a result of the associated increase in volume.

Silicon carbide foams were produced as described in Example 3 from the resulting foams coated with silicon carbide.

### EXAMPLE 5

The ceramic foams from Examples 3 and 4 were tested for suitability as flame zone structures in pore burners. The burner contained, in the flow direction, a premixing chamber, a perforated plate made of a fibrous material which formed the zone having a subcritical Peclet number and following this a foam structure produced by the process of the invention, which formed the flame zone. The burner was supplied with methane/air mixtures.

The start-up phase of the burner (time until the flame draws back into the foam) took about 5-10 seconds. At an initial power of 10 kW, uniform glowing in the flame zone was achieved within 12-15 seconds. In the case of conventional foams having a smaller pore size, this requires a longer time which is generally from about 20 to 30 seconds or more. The burners were operated at a maximum power of 30 kW for 240 seconds. This test was carried out using different air indices in the range from 1 to 1.3. The power was subsequently throttled back to 15 kW and the air index was increased to 1.4, and the gas supply was shut off in this state of operation but the air supply was maintained for cooling purposes. In all tests, the foams retained their mechanical strength and displayed no visible changes in shape. Conventional foams having smaller pores tested in comparative tests displayed a significantly lower stability toward thermal stress, which was shown, for example, by cracks, spalling or oxidation effects. In addition, greater radiation of heat was observed in the case of the foams according to the invention.

This application claims the priority, under 35 U.S.C. § 119, of European patent application No. 04 023 181.3, filed Sep. 29, 2004; the entire disclosure of the prior application is herewith incorporated by reference.

We claim:

1. A process for producing a final open-celled polyurethane foam having a mean pore count of less than 8 pores per inch (ppi), which comprises the steps of:
storing an open-celled polyurethane foam having a mean pore count of greater than or equal to 8 ppi in a substance having an aromatic skeleton and at least one hydroxy group and selected from the group consisting of a first substance being liquid and a second substance being dissolved in a solvent, and resulting in the open-celled polyurethane foam experiencing an increase in volume of at least 10%.

2. The process according to claim 1, which further comprises selecting the substance from the group consisting of:
benzyl alcohol, aqueous solutions of phenols, alcoholic solutions of phenols, aqueous solutions of phenolic resins, alcoholic solutions of phenolic resins, solutions of phenols in mixtures of water and at least one alcoholic solvent, and phenolic resins in mixtures of water and at least one alcoholic solvent.

3. The process according to claim 2, which further comprises using an aqueous solution of a phenol having a phenol content of more than 0.1% by mass.

4. The process according to claim 2, which further comprises using an aqueous or alcoholic solution of a phenolic resin of a resol type.

5. The process according to claim 1, which further comprises suspending ceramic or ceramic-forming particles in the substance in which the open-celled polyurethane foam is stored and the open-celled polyurethane foam being coated with the ceramic or ceramic-forming particles during a storage time.

6. The process according to claim 1, which further comprises applying a tensile stress to the open-celled polyurethane foam during storage in the substance.

7. A production method, which comprises the steps of: storing an open-celled polyurethane foam having a mean pore count of greater than or equal to 8 ppi in a substance having an aromatic skeleton and at least one hydroxy group and selected from the group consisting of a first substance being liquid and a second substance being dissolved in a solvent, resulting in a treated open-celled polyurethane foam experiencing an increase in volume of at least 10%; and
using the treated open-celled polyurethane foam for producing ceramicized foams or metallized foams having a mean pore count of less than 8 ppi.

8. The production method according to claim 7, which further comprises creating a pore structure for a flame zone of burners using the ceramicized foams having the mean pore count of less than 8 ppi.

9. A production method, which comprises the steps of:
storing an open-celled polyurethane foam having a mean pore count of greater than or equal to 8 ppi in a substance having an aromatic skeleton and at least one hydroxy group and selected from the group consisting of a first substance being liquid and a second substance being dissolved in a solvent, resulting in a treated open-celled polyurethane foam experiencing an increase in volume of at least 10%; and
using the treated open-celled polyurethane foam for producing a foam having a mean pore count of less than 8 ppi and selected from the group consisting of ceramicized foams and metal foams; and
using the foam for producing filters.
